(19) United States
(12) Patent Application Publication
(10) Pub. No.: US 2025/0348354 A1
(43) Pub. Date: Nov. 13, 2025

(54) PRE-SCHEDULING OPTIMIZATION FOR COMPUTER-IMPLEMENTED GENETIC ALGORITHMS

(71) Applicant: nMetric, LLC, Dallas, TX (US)

(72) Inventors: Christine Koski, Dallas, TX (US); Stephen Cook, Albuquerque, NM (US)

(21) Appl. No.: 18/661,033

(22) Filed: May 10, 2024

(51) Int. Cl. G06F 9/48

(52) U.S. Cl. CPC G06F 9/4887

(57) ABSTRACT

A system for increasing the computational efficiency of a scheduling system applying genetic algorithms. A computing device of the scheduling system collects a plurality of jobs, each having a plurality of tasks. The computing device then proceeds to locate one or more fixed tasks among all of the collected tasks and removes the fixed tasks from the pool of tasks to be scheduled. The computing device blocks off time and resources associated with the fixed tasks, and then proceeds to generate a genome from the remaining tasks. The genomes are then used by a genetic algorithm executed by the computing device to generate a schedule.

### FIELD OF THE INVENTION

The field of the invention is efficiency in schedule-generation computing systems.

### BACKGROUND

The background description includes information that may be useful in understanding the present invention. It is not an admission that any of the information provided herein is prior art or relevant to the presently claimed invention, or that any publication specifically or implicitly referenced is prior art.

The use of genetic algorithms for scheduling has led to great leaps in efficiency and effectiveness in terms of generating a schedule for organizations having many jobs with many moving pieces. By using a genetic algorithm, an organization is able to fit many complicated considerations into a working schedule in a way that was not previously possible.

However, even with these advancements in scheduling and job execution, there is still room for improvement.

Currently, the use genetic algorithms executed by scheduling computing devices involves feeding the genetic algorithm all possible jobs with all possible tasks and all possible resources, and then turning the genetic algorithm loose. In these cases, all of the tasks are added to the genome, without initial consideration of the tasks themselves other than the order. While this may ultimately achieve an optimal or near-optimal schedule, this approach is wasteful of computing resources because it is susceptible to considering tasks and/or resources that cannot be optimized via the genetic algorithm.

Thus, there is still a need for a computer-implemented genetic-algorithm-based scheduling system that improves the computing efficiency of the process, thereby reducing computational resources required for the overall process.

### SUMMARY OF THE INVENTION

The inventive subject matter provides apparatus, systems and methods in which a computer system can decrease waste of computing resources, electricity and time by effectively processing fixed tasks prior to the execution of a genetic algorithm.

A computing device obtains a plurality of jobs to be performed, each job having a plurality of tasks that have to be executed in order to complete the job. The computing devices identifies one or more fixed tasks among the tasks across all of the obtained jobs. A fixed task can be generally thought of as a task with little or no scheduling flexibility within a schedule. The lack of flexibility can come from the order of the task within a job, one or more of a required resource, the fact the task is already being executed, or other factors.

The computing device then removes the identified fixed tasks from the pool of possible tasks, and generates one or more genomes from the remaining tasks in the pool. When the genomes have been created, the computing device executes the genetic algorithm and generates a schedule for each of the genomes.

In these embodiments of the inventive subject matter, the fixed tasks are identified and removed from the pool of tasks before the genomes are even created.

Locating the fixed tasks can involve creating timelines for resources required for various tasks for each job, determining whether tasks can be scheduled for execution before the initiation of the genetic algorithm via one or more heuristics. The computing device then schedules the task as a fixed task.

In another embodiment of the inventive subject matter, the genomes are created from all of the available tasks, and after that the fixed tasks are identified.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1A is a diagrammatic view of several jobs and their respective tasks.

FIG. 1B is a diagram of a genome constructed from the tasks of the jobs of FIG. 1A

FIG. 2 is a flowchart illustrating the execution of processes according to inventive subject matter.

FIG. 3 shows a detailed view of the steps within step 240 of FIG. 2, according to embodiments of the inventive subject matter.

FIG. 4 is a flowchart illustrating the execution of a process according to an alternative embodiment of the inventive subject matter.

FIG. 5 shows a detailed view within the step 450 of FIG. 4, according to embodiments of the inventive subject matter.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

A computer-based scheduling system can account for one or more types of scheduling problems that can be based on factors such as the type of organization, the type of jobs and/or tasks involved, available times, etc. Some examples of the types of scheduling problems these systems are expected to handle include:

Open shop scheduling. In open shop scheduling, each job has a task on each available machine, without any types of ordering constraints. Thus, the tasks can be performed in any order. Typically, there's no parallel work on a job.

Flow shop scheduling: In flow shop scheduling, each job has a task on each machine. Unlike open shop scheduling, the order of the tasks matters in flow shop scheduling.

Permutation flow shop: Permutation flow ship is similar to flow shop scheduling, but the machine must perform the jobs (and the tasks therein) in the same order.

Job shop (“JSP”) scheduling, also known as Job-Shop Scheduling Problem (“JSSP”): the goal for JSP is to minimize “makespan”. This means that the goal for JSP is to compress the schedule as much as possible.

Flexible job shop (“FJSP”) scheduling: This is similar to the job shop scheduling, but the resources are interchangeable.

Truthful job scheduling: The resources available can perform any task in the job, but they take different time. For example, the resources can include personnel that have different skill levels at performing the task.

One challenge that computer-implemented scheduling systems face is that schedule generation for many jobs having many tasks is an “NP-hard” problem. For example, an open shop scheduling problem with “n” jobs and “m” resources has (n!)^{m} possible combinations. For 10 jobs with 10 resources, that means 3.95*1065 possible schedules.

While scheduling types with more restrictions have a lower potential amount of schedules, the combinations are still staggering and simply too many for a computer system to brute force a “best” schedule.

Current systems use simple heuristic deterministic scheduling algorithms:
R (Random)—Pick any Job in Queue with equal probability. This rule is often used as benchmark for other rules
FCFS (First Come First Serve)—Jobs are processed in the order in which they arrived at the work center (also called earliest release date)
SPT (Shortest Processing Time)—This rule tends to reduce both work-in-process inventory, the average job completion (flow) time, and average job lateness. SPT can also be used to break ties.
EDD (Earliest Due Date)—Choose Job that has earliest due date
CR (Critical Ratio)=Processing Time/Time until due (Due Date-Current Time). Take the highest value.
LWR (Least Work Remaining)—This rule is an extension of SPT variant that considers the number of successive operations
ST (Slack Time)=Time until job is due-(Sum of processing time remaining). Take the job with the smallest amount of slack time.
ST/O (Slack Time per Remaining Operation)=slack time divided by number of operations remaining. Take the job with the smallest amount of slack time per remaining Operation.

Existing systems have also employed more “complex” scheduling heuristics, such as Johnson's Algorithm (that uses Bellman-Ford), Kusiak's Algorithm, Palmer's Algorithm, Gupta's Algorithm, Shifting Bottleneck Algorithm, Campbell-Dudek-Smith (“CDS”) Algorithm, and/or Nawas-Enscore-Ham (“NEH”) Algorithm.

However, for the most part these all simply employ variations and/or combinations of the simple heuristics. While these approaches may get acceptable results in a human-scale amount of time, none are guaranteed to find optimal solutions.

Existing scheduling systems employ fitness functions that use common variables such as processing time, release date, due date, weight, lateness, makespan, and release date. Common fitness functions will then return “raw” fitness scores that can be combined with user-supplied specific factors to weight the fitness scores. For example, an output of the fitness function can be a measure of robustness, which reflects the sensitivity of the schedule to problems/interruptions in a flow. Typically, to improve robustness, a system can add idle times, schedule less flexible jobs first, and forward-schedule as many tasks as possible. In another example, the output of the fitness function can be a measure of tightness, which minimizes the absolute size of the lateness.

As discussed herein a job is made up of tasks. Tasks are discrete functions or processes that are the subparts of a job. The tasks of a job are often sequential such that one or more tasks may need to be completed for a subsequent one or more tasks of a job to start.

A task requires one or more resources to complete. A resource can be anything that a task may need to be completed. Examples of resources can include equipment, personnel, locations, etc.

A genome as discussed herein can be considered to be a list of tasks. In the examples discussed herein, a genome can include all of the tasks from all of the jobs associated with an organization or a process within an organization.

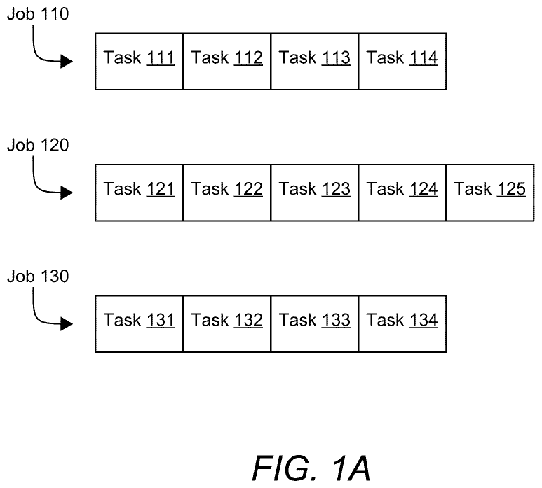

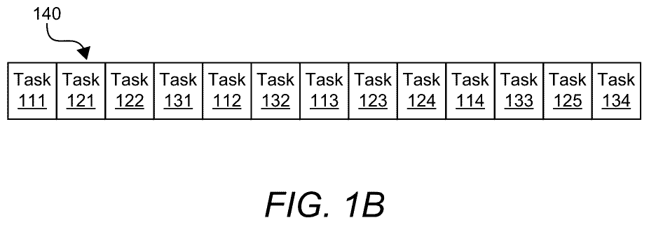

An example of the assembly of a genome is seen in FIGS. 1A and 1B.

FIG. 1A illustrates a plurality of jobs 110, 120, 130 with their respective tasks organized sequentially according to the job. Thus, job 110 will have task 1 (block 111), task 2 (block 112), task 3 (block 113) and task 4 (block 114) that need to be performed for the job 110 to be completed. Likewise, job 120 has tasks 1-5 (blocks 121-125, respectively) and job 130 has tasks 1-4 (blocks 131-134, respectively).

To create a genome, a computing device gets all of the tasks associated with all of the jobs and mixes them up to create a list from all of these tasks. FIG. 1B shows an example of a genome 140 created from all of the tasks of jobs 110, 120 and 130. Generally speaking the tasks can be mixed up in almost any order, though the assembly of a genome can be subject to rules. For example, one rule of a genome is that the tasks must be for any job along the length of the genome. This means that while the tasks of a genome are not required to be consecutive or next to one another, a task for a job cannot precede an earlier task from the same job. Thus, in this example, task 3 (block 113) of job 110 cannot be before task 2 (block 112) of the same job 110 within an assembled genome.

The jobs 110, 120, 130 and their respective tasks are relatively small in number for the purposes of illustration. It is contemplated that, in preferred embodiments, the system will handle over 10 jobs with over 10 tasks each. In still other preferred embodiments, the system will be tasked to handle over 100 jobs with many tasks (over 10, over 100, over 1000). Systems handling orders of magnitude more jobs and tasks will see increased benefits of the systems and methods of the inventive subject matter.

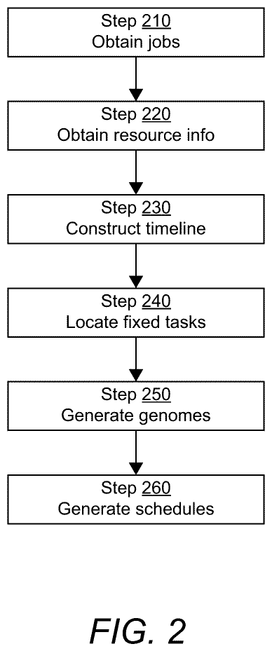

FIG. 2 is a flowchart illustrating the execution of processes according to inventive subject matter.

At step 210, a computing device obtains a plurality of jobs to be scheduled, each of the plurality of jobs themselves having a plurality of tasks.

The jobs (and their respective tasks) can be stored in a database accessible to the computing device. The database can be local to or remotely from the computing device. The jobs and the tasks therein can be initially provided via a user input, and they can be modified accordingly.

At step 220, the computing device obtains information regarding a plurality of resources to be used to execute or otherwise carry out the plurality of tasks.

At step 230, the computing device constructs a timeline for each resource from the plurality of resources. The timeline for each resource comprises a listing or other assembly of the times that the resource is known to be unavailable and times that the resource is available. Thus, each resource will have a status of “available” or “unavailable” for each time segment in the timeline.

At step 240, the computing device locates at least one fixed task among the plurality of tasks across all of the obtained jobs.

A fixed task is a task having a block, scheduling inflexibility, or otherwise having constraints such that the task must be performed at a particular point in time.

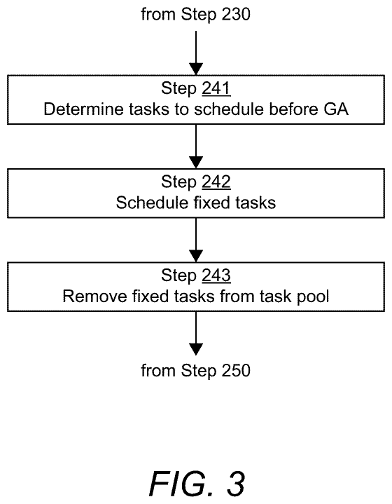

FIG. 3 shows a detailed view of the steps within step 240, according to embodiments of the inventive subject matter.

At step 241, the computing device determines which tasks can be scheduled before the genetic algorithm process. The computing device can do this by applying one or more heuristics to each task based on the nature of their status. The output of step 241 is a determination of a task as fixed, and a heuristically-calculated position among all of the tasks.

Fixed tasks can be tasks from one or more of the following categories:

Executing/in-process tasks: These are tasks whose execution has already started so it is undesirable to interrupt them only to schedule them for later.

Anchored tasks: These are tasks that are pinned to a specific time and resource.

Dispatch tasks: Tasks having a user-defined duration where tasks must remain in consistent order.

“Hot” tasks (priority over dispatch): These are tasks that take priority over dispatch tasks. These tasks can be user-specified.

“Hot” tasks (no priority over dispatch). These are tasks that do not take priority over dispatch tasks. These tasks can be user-specified.

Bus Scheduled Tasks: Tasks grouped into “buses” where order matters the most.

At step 242, the computing device schedules any tasks that have been determined to be fixed tasks according to their heuristically-calculated position.

At step 243, the computing device removes the fixed tasks from the pool of tasks among all of the jobs, such that they are not considered by the genetic algorithm.

At step 250, the computing device then proceeds to generate one or more genomes (preferably, multiple genomes) from the remaining tasks (after removal of the fixed tasks) across all the jobs and uses the genetic algorithm to generate a schedule from each of the genome(s) at step 260.

The computing device can then select the best schedule from the generated schedules. In embodiments of the inventive subject matter, the computing device can mutate one or more of the genomes and execute the genetic algorithm again to determine whether a better schedule can be found in the mutated genomes. Each of these mutations and re-executions of the genetic algorithm can be considered “rounds” of schedule generation. In each round, the fixed tasks remain removed from the pool of tasks used to generate the genomes since their availability/lack of flexibility within the schedule will not change and must always be accounted for.

The timelines and/or the list of fixed tasks can be saved. This way, if one or more of the genomes need to be mutated and the genetic algorithm rerun to generate new schedules, the fixed tasks can be left off of the new genomes for the additional rounds of the genetic algorithm. This saves computational resources and time.

Because fixed tasks do not have flexibility in scheduling, including them in the genetic algorithm does not provide a benefit. In fact, including fixed tasks in the genetic algorithm simply gives the genetic algorithm additional variables to consider. This results in increased time and computing power required to generate a schedule. Thus, the systems and methods discussed herein reduce the waste of computing resources in generating schedules with genetic algorithms.

Additionally, storing and reusing the timelines for additional generations of the genetic algorithm increases the efficiency of the system and reduces the amount of computational resources used because the timelines do not have to be generated anew for each successive generation.

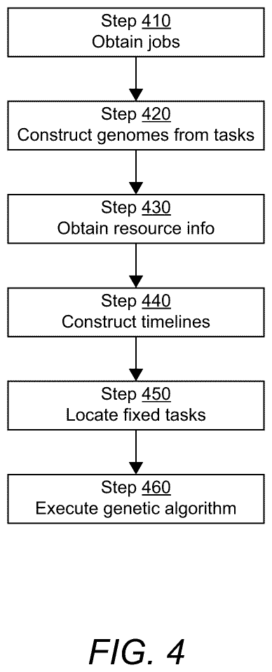

FIG. 4 is a flowchart illustrating the execution of a process according to an alternative embodiment of the inventive subject matter. The process depicted in the flowchart of FIG. 4 is similar to that of the embodiment of FIG. 2. The principal difference is that in FIG. 2, the fixed tasks are removed prior to the genomes being created. In the embodiment shown in FIG. 4, the genomes are created and the fixed tasks are then identified and removed before the genetic algorithm is executed.

Thus, step 410 corresponds to step 210 of FIG. 1. At step 410, the computing device obtains a plurality of jobs to be scheduled, each of the plurality of jobs themselves having a plurality of tasks.

At step 420, the computing device constructs one or more genomes from the tasks across the jobs.

At step 430, the computing device obtains information regarding a plurality of resources to be used to execute or otherwise carry out the plurality of tasks.

At step 440, the computing device constructs a timeline for each resource from the plurality of resources. As with the embodiment of FIG. 2, a timeline for each resource comprises a listing or other assembly of the times that the resource is known to be unavailable and times that the resource is available. Thus, each resource will have a status of “available” or “unavailable” for each time segment in the timeline.

At step 450, the computing device locates at least one fixed task among the plurality of tasks across all of the obtained jobs.

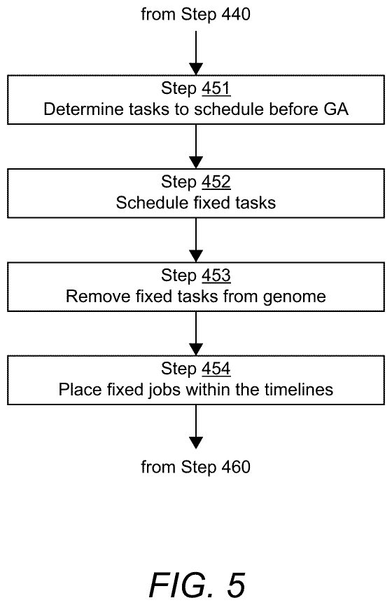

FIG. 5 shows a detailed view within the step 450 of FIG. 4. The steps 451-453 shown in FIG. 5 mirror steps 241-243 of FIG. 3.

At step 451, the computing device determines which tasks can be scheduled before the genetic algorithm process. The computing device can do this by applying one or more heuristics to each task based on the nature of their status. The output of step 241 is a determination of a task as fixed, and a heuristically-calculated position among all of the tasks. Fixed tasks can be tasks from one or more of the categories described above.

At step 452, the computing device schedules any tasks that have been determined to be fixed tasks according to their heuristically-calculated position.

At step 453, the computing device removes the fixed tasks from the genomes among all of the jobs, such that they are not considered by the genetic algorithm.

At step 454, the computing device places the fixed jobs within the timelines according to their heuristically-calculated position, such that those places within the timelines are blocked.

At step 460, the computing device executes the genetic algorithm for the modified genomes (the genomes without the fixed tasks), taking into account the aspects of the timelines having the fixed tasks, to generate a schedule for each genome. Thus, the genetic algorithm does not consider the fixed tasks during execution and works around the times that the fixed tasks take place within the timelines.

As with the embodiment of FIG. 2, the genetic algorithm can be executed for multiple rounds to find a best-fit schedule. As such, the timelines and/or the list of fixed tasks can be saved for subsequent rounds of the genetic algorithm with mutated genome(s).

The systems and methods of the inventive subject matter are discussed herein as being executed by a computing device or computing system. The computing device is contemplated to have one or more processors, one or more non-transitory computer-readable storage medium to store executable code/instructions as well as data used in the processes discussed herein. The systems can include databases integral to or remotely from the computing devices that can store jobs (and the tasks therein). The computing devices have networking capabilities to exchange data with other computing devices, and have input/output interfaces that allow for human operators to enter and receive data/information. While “computing device” in the singular is used herein for simplicity, it is understood that the computing device can be a single computer having the components discussed herein or a plurality of communicatively connected computing devices that collectively carry out the functions and processes discussed herein.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for optimizing an execution of a genetic algorithm, comprising a computing device having a processor programmed to:
prior to the execution of a genetic algorithm, locate at least one fixed task among a plurality of tasks needed to complete a job among a plurality of jobs;
block off a necessary time and at least one necessary resource for the at least one fixed task;
remove the at least one fixed task from a list of the plurality of tasks belonging to the plurality of jobs;
generate at least one genome from the remaining tasks; and
initiate the genetic algorithm to generate a schedule from the genome of the remaining tasks from the list of the plurality of tasks such that the at least one fixed task will not be inserted into the genome or considered by the genetic algorithm.

2. The system of claim 1, wherein the at least one fixed task comprises a task from at least one of an in-progress task, an anchored task, a hot task, a dispatch task, an unprioritized hot task, and a bus scheduled task.

3. The system of claim 1, wherein the processor programmed to locate of the at least one fixed task comprises the processor programmed to:
create a timeline for each resource;
determine, through at least one heuristic, at least one task from the plurality of tasks that can be scheduled for execution before the initiation of the genetic algorithm; and
schedule the at least one task as the at least one fixed task before the initiation of the genetic algorithm.

4. The system of claim 3, wherein the at least one task from the plurality of tasks is determined based on a status associated with the at least one task.

5. The system of claim 3, further comprising the processor programed to store at least one of the timeline for each resource or the at least one fixed task.

6. The system of claim 5, further comprising the processor programmed to use the generated at least one timeline for at least one successive generation of genetic algorithm execution.

7. A system for optimizing an execution of a genetic algorithm, comprising a processor programmed to:
generate a genome from a plurality of tasks for a plurality of jobs;
prior to the execution of a genetic algorithm, locate at least one fixed task among the plurality of tasks;
block off a necessary time and at least one necessary resource within the schedule for the at least one fixed task;
remove the at least one fixed task from the genome; and
initiate the genetic algorithm to generate a schedule from the remaining tasks from the genome such that the at least one fixed task will not be considered by the genetic algorithm.

8. The system of claim 7, wherein the at least one fixed task comprises a task from at least one of an in-progress task, an anchored task, a hot task, a dispatch task, an unprioritized hot task, and a bus scheduled task.

9. The system of claim 7, wherein the locating of the at least one fixed task comprises:
create a timeline for each resource;
determine, through at least one heuristic, at least one task from the plurality of tasks that can be scheduled for execution before the initiation of the genetic algorithm; and
schedule the at least one task as the at least one fixed task for execution before the initiation of the genetic algorithm.

10. The system of claim 9, wherein the at least one task from the plurality of tasks is determined based on a status associated with the at least one task.

11. The system of claim 9, further comprising the processor programed to store at least one of the timeline for each resource or the at least one fixed task.

12. The system of claim 11, further comprising the processor programmed to use the generated at least one timeline for at least one successive generation of genetic algorithm execution.
